(19) United States
(12) Patent Application Publication
(10) Pub. No.: US 2014/0207510 A1
(43) Pub. Date: Jul. 24, 2014

(54) REDUCING MEETING TRAVEL

(71) Applicant: TARGET BRANDS, INC., Minneapolis, MN (US)

(72) Inventor: Christopner Paul Valle, Innver Grove Heights, MN (US)

(73) Assignee: TARGET BRANDS, INC., Minneapolis, MN (US)

(21) Appl. No.: 14/153,749

(22) Filed: Jan. 13, 2014

Related U.S. Application Data
(60) Provisional application No. 61/754,268, filed on Jan. 18, 2013.

(51) Int. Cl. G06Q 10/10

(52) U.S. Cl. CPC G06Q 10/1095
USPC 705/7.19

(57) ABSTRACT

A computing device retrieves meeting data from an electronic scheduling system. The meeting data includes a plurality of meetings, each of which is associated with a meeting location in a building including a plurality of floors and at least one elevator, a period of time, and one or more participants. The computing device determines a participant location for each participant associated with each of the meetings. The computing device determines a meeting travel metric for each of the meetings based on the participant locations and the meeting location of the meeting. The computing device causes the scheduling system to change the meeting location associated with one or more of the meetings based on the meeting travel metric determined for each of the one or more of the meetings.

### CROSS REFERENCE TO RELATED APPLICATION

This application claims the benefit of priority to U.S. provisional application No. 61/754,268, filed Jan. 18, 2013, which application is incorporated herein by reference in its entirety.

### TECHNICAL FIELD

This disclosure relates to reducing the travel required to attend meetings.

### BACKGROUND

Group meetings including a number of people are a frequent part of employee responsibilities in some organizations. Travel to and from meetings can take a significant. amount of time. As meeting travel time may be generally considered non-productive time for employees, reducing the time it takes to travel to and from meetings can be valuable to organizations for a number of different reasons.

### SUMMARY

Examples according to this disclosure are directed to reducing the amount of travel (e.g. distance and/or time) required to attend meetings in a building including multiple floors. In one example, a method includes retrieving, by a computing device, meeting data from an electronic scheduling system. The meeting data includes a plurality of meetings, each of which is associated with a meeting location in a building including a plurality of floors and at least one elevator, a period of time, and one or more participants. The computing device determines a participant location for each participant associated with each of the meetings. The computing device determines a meeting travel metric for each of the meetings based on the participant locations and the meeting location of the meeting. The meeting travel metric is indicative of a distance between each participant location of each participant and the meeting location. The distance is based at least in part on the number of floors the participant travels from the participant location to the meeting location to attend the meeting.

The computing device causes the scheduling system to change the meeting location associated with one or more of the meetings based on the meeting travel metric determined for each of the one or more of the meetings.

In another example, a computing device includes at least one computer-readable storage device and at least one processor. The at least one processor is configured to access information stored on the at least one computer-readable storage device and to perform operations comprising obtain data from an electronic calendar system that indicates a plurality of electronically scheduled meetings, each of which is associated with a meeting location, a period of time, one or more participants, and a location of each participant from which the participant is required to travel to attend the meeting, and determine anew meeting location for one or more of the meetings that reduces travel distance of each meeting. The travel distance of each meeting is based on the participant locations and the meeting location. The at least one processor is also configured to cause the calendar system to change the meeting location associated with each of the one or more meetings to the new meeting location.

In another example, a computer-readable storage medium includes instructions that, if executed by a computing device having one or more processors, cause the computing device to perform operations that include obtaining meeting data from all electronic calendar system for a plurality of electronically scheduled meetings, determining, for each of the meetings, a meeting location, a period of time, one or more participants, and a location of each participant from which the participant is required to travel to attend the meeting, and iteratively changing the meeting location of each of the meetings and determining travel distance of the meeting based on the participant locations and the meeting location to reduce a total distance that all participants of the meeting are required to travel to attend the meeting.

The details of one or more examples are set forth in the accompanying drawings and the description below. Other features, objects, and advantages of examples according to this disclosure will be apparent from the description and drawings, and from the claims.

### BRIEF DESCRIPTION OF DRAWINGS

FIG. 1 is a block diagram illustrating an example computing system configured to reduce the amount of travel required to attend electronically scheduled meetings.

FIG, 2 is a block diagram illustrating an example computing device configured to process meeting data associated with meetings electronically scheduled in an electronic scheduling system.

FIG. 3 is a flowchart illustrating an example method of reducing the amount of travel required to attend a meeting.

FIGS, 4 and 5 are conceptual diagrams illustrating distance to and travel optimization for a meeting attended by a number of participants in a building including multiple banks of elevators.

FIGS. 6A and 6B are conceptual diagrams illustrating an example meeting notification that can be used to inform meeting participants of meeting changes generated in accordance with examples of this disclosure.

FIG. 7 is an example floor displacement grid that can be employed to determine meeting travel metrics indicative of distances between participant locations and a meeting location.

### DETAILED DESCRIPTION

As noted above, travel to and from meetings can take a significant amount of time. One reason for the amount of travel time required for meetings is that relatively large organizations, such as large companies, are commonly located in a building including multiple floors connected by stairs and elevators. In some cases, such buildings will include a large enough number of people and floors that the building includes multiple banks of elevators, each of which services a specific range of floors. Travel between different locations in a. building serviced by a multi-bank elevator system may be significantly increased because traveling only a few floors can require a disproportionately long elevator ride on multiple banks of elevators. As meeting travel time may be generally considered non-productive time for employees, reducing the time it takes to travel to and from meetings can be valuable to organizations for a number of different reasons,

Meetings in an organization may be scheduled using an electronic calendar system with little or no particular regard to the amount of travel (distance and/or time) that will be required of participants to attend the meeting. Although meeting organizers may attempt to schedule meetings at convenient locations for the participants, the ability to do this may be limited by the functionality of many electronic calendar systems. For example, calendar systems commonly reserve resources including meeting locations (e.g. conference rooms) on first come first serve basis such that little to no consideration is given to an optimal set of locations in a building at any particular time. Additionally, scheduling particular locations in a building including a large number of possible locations and a large number of people competing for such locations may be difficult and even impractical using existing electronic calendar systems.

In order to address these and other challenges with scheduling and traveling to meetings in a multi-story building, examples according to this disclosure provide systems and methods for reducing the amount of travel (e.g. distance and/or time) required to attend meetings in such buildings. In general, examples according to this disclosure are configured to retrieve and analyze meeting data from an electronic calendar system for a period of time including a number of electronically scheduled meetings, e.g., for a day's meetings in a multi-story building. The meeting locations and locations of participants attending the meetings are analyzed across all of the meetings in the meeting data for the time period. New meeting locations of one or more of the scheduled meetings are determined to decrease the total amount of travel (e.g. distance and/or time) of all of the participants of the meeting. The calendar system then changes the locations of the scheduled meetings and, in some examples, notifies participants of the changes. In this manner, meeting organizers and participants are free to schedule, manage, review, etc. electronically scheduled meetings in substantially the same manner as always using their existing electronic calendar system, while examples according to this disclosure automatically reschedule meeting locations to minimize travel to and from the meetings and automatically notify participants of the changed locations. The process of meeting location optimization in accordance with this disclosure can thus be substantially transparent to end-users of the calendar system, white still improving user productivity by reducing the amount of unproductive time spent traveling to meetings.

Examples according to this disclosure can provide a number of advantages. Optimizing building resource usage, including, e.g., meeting locations and elevators, by reducing travel may have the effect of arranging people within an organization in more logical, efficient layers, which may be thought of as a process of stratification. As noted above, travel to and from meetings can take a relatively large amount of time, which may be generally non-productive time for employees. Thus, an effect of such stratification that reduces meeting travel may be increasing productivity for an organization. Such improvements may also increase employee work life satisfaction by, e.g., reducing the amount of time employees have to spend waiting for and traveling on elevators.

Improving meeting travel time for relatively large organizations can translate into substantial, concrete benefits to the organization. Consider, for example, an organization located in a large building serviced by a multi-bank elevator system. In such an example it may not be uncommon for employees to spend an average of two hours per week traveling for scheduled meetings in the building. In one example, an average employee costs an organization approximately 65 dollars per hour. In such a case, meeting travel time equates to an annual cost (or lost productivity) of approximately 6.5 million dollars per 1000 employees (2 hours/week×50 weeks/year×1 year×1000 employees×75 dollars/hour and employee). Additionally for each employee in this example, travel time represents 100 hours per year, which may be approximately equivalent to 2 and ½ weeks of full-time work traveling to and from meetings.

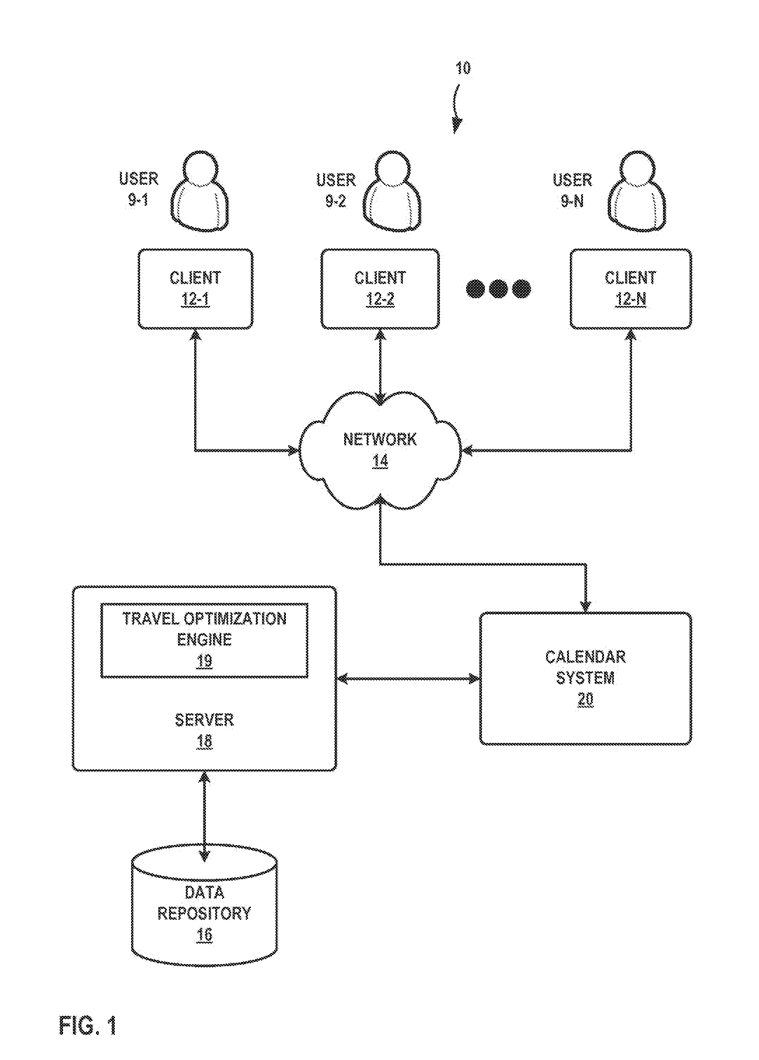

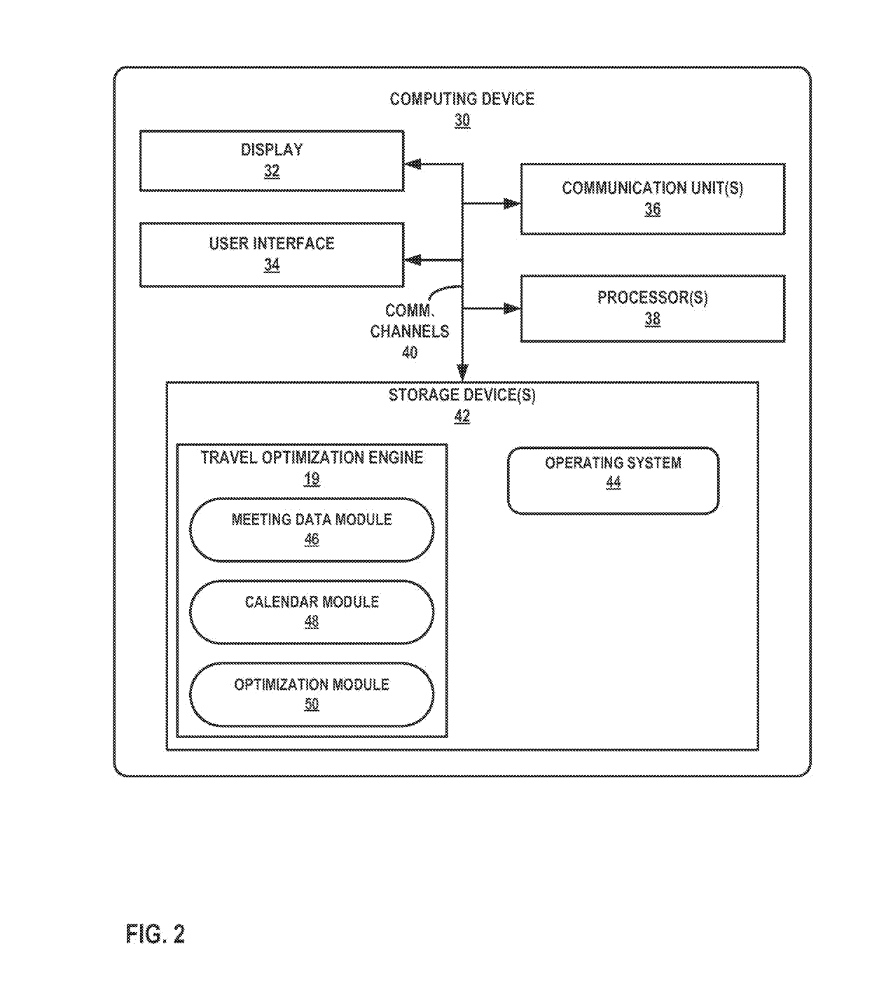

FIG. 1 is a block diagram illustrating example computing system 10 including client computing devices 12-1-12-N (collectively “clients 12” or individually “client 12”), network 14, data repository 16, server 18, and electronic calendar system 20. Clients 12-1-12-N are respectively associated with users 9-1-9-N (collectively “users 9” or individually “user 9”). In examples according to this disclosure, users 9 may also be referred to as meeting participants and/or organizers. Clients 12 are communicatively connected to data repository 16, server 18, and calendar system 20 via network 14. Clients 12 are configured to communicate with calendar system 20 to allow users 9 to electronically schedule meetings. Clients 12 are configured to, in conjunction with calendar system 20, associate meeting locations in a multi-story building and meeting participants for one or more of the scheduled meetings. In one example, clients 12 include an electronic calendar client application. some cases, the client application and associated functions may be part of a suite of functionality provided by one or more client applications, including, e.g., electronic mail and contact management client applications.

In the example of FIG. 1, clients 12 are not communicatively connected to server 18 because clients 12 may be configured for use by end-users 9 to schedule meetings, among other end-user functions, and because end-users 9 need not communicate with server 18 to accomplish such tasks. In another example, however, one or more client computing devices can be communicatively connected to server 18. For example, a client device communicatively connected to server 18 can be employed by a system administrator to manage server 18 and/or data repository 16. Additionally, in one example, one or more of clients 12 are communicatively connected to server 18, either directly or via network 14 or another network.

Calendar system 20 and server 18 are configured to periodically communicate with one another. Although illustrated as directly connected in the example of FIG. 1, in another example, calendar system 20 and server 18 can be connected via network 14 or another network including structure and functions similar to those described below with reference to network 14. Server 18 is configured to retrieve meeting data from calendar system 20 and analyze the meeting data. Communication of meeting data between server 18 and calendar system 20 can occur periodically at varying time intervals or continuously as such data is created, changed, or deleted by calendar system 20. Server 18 can be configured to pull meeting data from calendar system 20. Additionally, calendar system 20 can be configured to push meeting data to server 18. In some cases, server 18 may store meeting data and other data in data repository 16. Server 18 includes travel optimization engine 19, which can be employed to reduce the amount of travel (e.g. distance and/or time) required to attend meetings scheduled by calendar system 20.

Clients 12 can include any number of different portable electronic mobile devices, including, e.g., cellular phones, personal digital assistants (PDA's), laptop computers, portable gaming devices, portable media players, e-book readers, watches, as well as non-portable devices such as desktop computers. Clients 12 can include one or more input/output devices configured to allow user interaction with one or more programs configured to communicate with calendar system 20. In one example, clients 12 include client computers from which users 9 access and interact with electronic calendar system 20 to schedule meetings in a multi-story building. In one example, clients 12 run a web browser that accesses and presents a web application executed by server 18 or another device and allows users 9 to schedule meetings in the building. In another example, clients 12 execute an application outside of a web browser, e.g. an operating system specific application that allows users 9 to schedule meetings in the building.

Network 14 can include one or more terrestrial and/or satellite networks interconnected to provide a means of communicatively connecting clients 12 to calendar system 20. In one example, network 14 is a private or public local area network (LAN) or Wide Area Network (WANs). Network 14 can include both wired and wireless communications according to one or more standards and/or via one or more transport mediums. In one example, network 14 includes wireless communications according to one of the 802.11 or Bluetooth specification sets, or another standard or proprietary wireless communication protocol. Network 14 can also include communications over a terrestrial cellular network, including, e.g. a GSM (Global System for Mobile Communications), CDMA (Code Division Multiple Access), EDGE (Enhanced Data for Global Evolution) network. Data transmitted over network 14, e.g., from clients 12 to calendar system 20 can be formatted. in accordance with a variety of different communications protocols. For example, all or a portion of network 14 can be a packet-based, Internet Protocol (IP) network that communicates data from clients 12 to calendar system 20 in Transmission Control Protocol/Internet Protocol (TCP/IP) packets, over, e.g., Category 5, Ethernet cables.

Data repository 16 can include, e.g., a standard or proprietary electronic database or other data storage and retrieval mechanism. In one example, data repository 16 includes one or more databases, such as relational databases, multi-dimensional databases, hierarchical databases, object-oriented databases, or one or more other types of databases. Data repository 16 can be implemented in software, hardware, and combinations of both. In one example, data repository 16 includes proprietary database software stored on one of a variety of storage mediums on a data storage server connected to server 18 and configured to store information associated with meetings electronically scheduled by calendar system 20, e.g. meeting data. Storage media included in or employed in cooperation with data repository 16 can include, e.g., any volatile, non-volatile, magnetic, optical, or electrical media, such as a random access memory (RAW, read-only memory (ROM), non-volatile RAM (NVRAM), electrically-erasable programmable ROM (EEPROM), flash memory, or any other digital media.

Server 18 includes travel optimization engine 19, which is employed, as described below, to reduce the amount of travel (e.g. distance and/or time) required to attend meetings scheduled by calendar system 20. Server 18 can be any of several different types of network devices. Examples of server 18 include a data processing appliance, web server, specialized media server, personal computer operating in a peer-to-peer fashion, or another type of network device. Travel optimization engine 19 can be implemented in hardware, software, or a combination of both and can include one or more functional modules configured to execute various functions attributed to travel optimization engine 19. Additionally, although example system 10 of FIG. 1 includes one server 18, other examples include a number of collocated or distributed servers configured to process meeting data associated with meetings electronically scheduled by calendar system 20 individually or in cooperation with one another.

Although data repository 16 and server 18 are illustrated as separate components in example system 10 of FIG. 1, in other examples the components are combined or each is distributed amongst more than one device. In one example, server 18 stores data repository 16 and controls the repository to periodically retrieve meeting data from calendar system 20. In another example, data repository 16 is distributed among a number of separate devices, e.g. a number of database servers, and server 18 includes a number of co-located or distributed servers configured to operate individually and/or in cooperation with one another and with the various devices comprising data repository 16.

Regardless of the particular configuration of system 10, or other example systems according to this disclosure, the system may be employed to reduce the amount of travel (e.g. distance and/or time) required to attend meetings scheduled by calendar system 20. In one example, travel optimization engine 19 retrieves meeting data from calendar system 20. Communication of meeting data between server 18 and calendar system 20 can be implemented in a variety ways including, e.g., travel optimization engine 19 pulling meeting data from calendar system 20 or calendar system 20 pushing meeting data to server 18. As used in this disclosure, meeting data may refer to data associated with a plurality of electronically scheduled meetings, each of which is associated with a meeting location in a multi-story building including at least one elevator, a period of time, and one or more participants.

Travel optimization engine 19 determines a participant location for each participant associated with each meeting. The location of a participant of a meeting includes a location at which the participant is anticipated to be prior to the meeting associated with the reservation with which the participant is associated by the meeting data. Travel optimization engine 19 determines a meeting travel metric for each of the meetings. Although possibly expressed in different forms, e.g., distance or time, the meeting travel metric is indicative of a distance between each participant location of each participant and the meeting location. The distance between each participant location and the meeting location is based at least in part on the number of floors the participant travels from the participant location to the meeting location to attend the meeting. Travel optimization engine 19 communicates with calendar system 20 to cause calendar system 20 to change the meeting location associated with one or more of the meetings based on the meeting travel metric of each meeting.

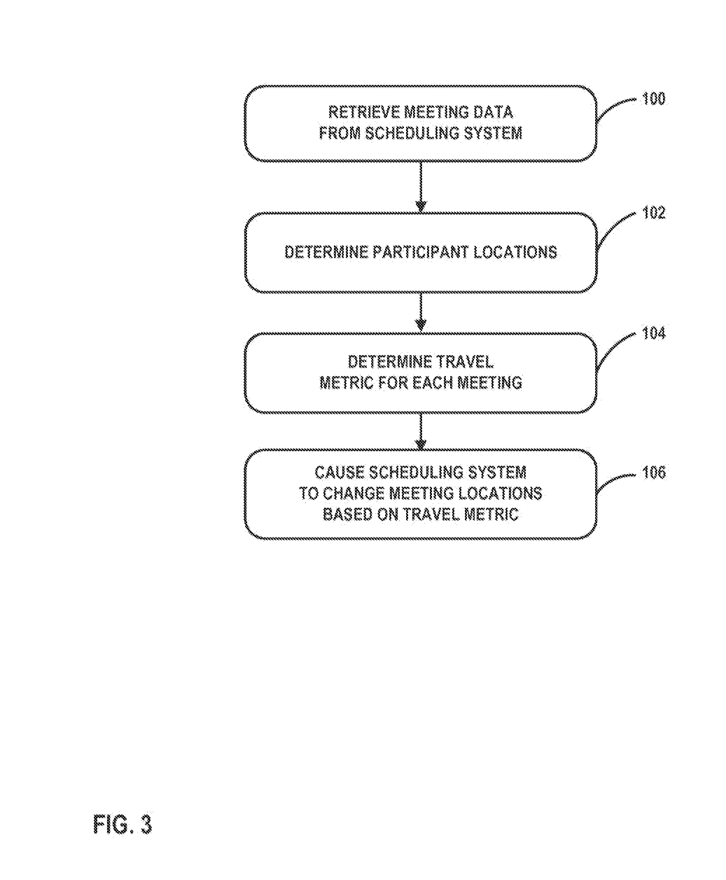

As will be described in more detail below, travel optimization engine 19 can cause calendar system 20 to change the meeting location of reservations based on the meeting travel metric in a variety of ways. For example, travel optimization engine 19 can include one or more algorithms based on a variety of optimization techniques to minimize the total travel for all participants of each meeting of the meeting data retrieved from calendar system 20. In one example, travel optimization engine 19 employs a brute force optimization technique that iterates through every possible meeting location for each meeting and associated participants in each time slot, e.g., 30 minute increments, over a larger period of time, e.g., one day, to reach a solution that minimizes the total travel for all participants of each meeting of the meeting data retrieved from calendar system 20. In other examples, travel optimization engine 19 may employ various techniques to potentially narrow the number of combinations iterated through to reach a solution that minimizes travel, including, e.g. applying one or more heuristics to limit the number of possible combinations included in the optimization or to begin by iterating through combinations with a higher likelihood of producing an acceptable solution. Additional details regarding the manner in which travel optimization engine 19 or other such mechanisms reduce the amount of travel (e.g. distance and/or time) required to attend meetings scheduled by an electronic calendar system are described below with reference to FIGS. 2 and 3.

FIG. 2 is a block diagram illustrating an example computing device 30 that is configured to process meeting data associated with meetings electronically scheduled in a calendar or other electronic scheduling system. FIG 2 illustrates only one example of computing device 30, and many other examples of computing device 30 can be used in other instances. In addition, although discussed with respect to one computing device 30, one or more components and functions of computing device 30 can be distributed among multiple computing devices 30.

Computing device 30 is, in certain examples, substantially similar to server device 18 of FIG. 1. As such, examples of computing device 30 include, but are not limited to, various types of network devices such as a data processing appliance, web server, specialized media server, personal computer operating in a peer-to-peer fashion, or another type of network device. Additional examples of computing device 30 include, but are not limited to, computing devices such as desktop computers, workstations, network terminals, and portable or mobile devices such as personal digital assistants (PDAs), mobile phones (including smart phones), tablet computers, laptop computers, netbooks, ultrabooks, and others.

As shown in the example of FIG. 2, computing device 30 includes display 32, user interface 34, one or more communication units 36, one or more processors 38, and one or more storage devices 42. As illustrated, computing device 30 further includes travel optimization engine 19 and operating system 44. Travel optimization engine 19 includes meeting data module 46, calendar module 48, and optimization module 50. Each of components 32, 34, 36, 38, and 42 are interconnected (physically, communicatively, and/or operatively) for inter-component communications. In some examples, communication channels 40 include a system bus, network connection, inter-process communication data structure, or any other channel for communicating data. As one example in FIG. 2, components 32, 34, 36, 38, and 42 are coupled by one or more communication channels 40. Travel optimization engine 19, meeting data module 46, calendar module 48, optimization module 50, and operating system 44 also communicate information with one another as well as with other components of computing device 30.

Display 32 can be a liquid crystal display (LCD), e-ink, organic light emitting diode (OLED), or other display, Display 32 presents the content of computing device 30 to a user. For example, display 32 displays the output of travel optimization engine 19 executed on one or more processors 38 of computing device 30, confirmation messages, indications, or other functions that may need to be presented to a user. In some examples, display 32 provides some or all of the functionality of a user interface of computing device 30. For instance, display 32 can be a touch-sensitive and/or presence-sensitive display that can display a graphical user interface (GUI) and detect input from a user in the form of user input gestures using capacitive or inductive detection at or near the presence-sensitive display.

User interface 34 allows a user of computing device 30 to interact with computing device 30. Examples of user interface 34 include, but are not limited to, a keypad embedded on computing device 30, a keyboard, a mouse, a roller ball, buttons, or other devices that allow a user to interact with computing device 30. In some examples, computing device 30 does not include user interface 34, and the user interacts with computing device 30 with display 32 (e.g., by providing various user gestures). In some examples, the user interacts with computing device 30 with user interface 34 and display 32.

Computing device 30, in some examples, also includes one or more communication units 36. Computing device 30, in one example, utilizes communication units 36 to communicate with external devices (e.g., clients 12 of FIG. 1) via one or more networks, such as wireless, cellular, or other types of networks. Communication units 36 can be a network interface card, such as an Ethernet card, an optical transceiver, a radio frequency transceiver, or any other type of device that can send and receive information. Other examples of such network interfaces include Bluetooth, 3G and WiFi radio computing devices as well as Universal Serial Bus (USB).

One or more processors 38 (hereinafter “processors 38”), in one example, are configured to implement functionality and/or process instructions for execution within computing device 30. For example, processors 38 are capable of processing instructions stored at one or more storage devices 42, which include, in some examples, instructions for executing functions attributed to travel optimization engine 19 and the modules thereof. Examples of processors 38 include any one or more of a microprocessor, a controller, a digital signal processor (DSP), an application specific integrated circuit (ASIC), a field-programmable gate array (FPGA), or equivalent discrete Or integrated logic circuitry.

One or more storage devices 42 (hereinafter “storage devices 42”) can be configured to store information within computing device 30 during operation. Storage devices 42, in some examples, are described as a computer-readable storage medium. In some examples, storage devices 42 include a temporary memory, meaning that a primary purpose of one or more storage devices 42 is not long-term storage. Storage devices 42 are, in some examples, described as a volatile memory, meaning that storage devices 42 do not maintain stored contents when the computer is turned off. Examples of volatile memories include random access memories (RAM), dynamic random access memories (DRAM), static random access memories (SRAM), and other forms of volatile memories known in the art. In some examples, storage devices 42 are used to store program instructions for execution by one or more processors 38. Storage devices 42, for example, are used by software or applications running on computing device 30 (e.g., travel optimization engine 19) to temporarily store information during program execution.

Storage devices 42, in some examples, also include one or more computer-readable storage media. Storage devices 42 can be configured to store larger amounts of information than volatile memory. Storage devices 42 can further be configured for long-term storage of information. In some examples, storage devices 42 include non-volatile storage elements. Examples of such non-volatile storage elements include magnetic hard discs, optical discs, floppy discs, flash memories, or forms of electrically programmable memories (EPROM) or electrically erasable and programmable (EEPROM) memories.

As illustrated in FIG. 2, computing device 30 includes travel optimization engine 19. Travel optimization engine 19 includes meeting data module 46, calendar module 48, and optimization module 50. Calendar module 48 is configured to retrieve meeting data associated with electronically scheduled meetings from an external calendar or other electronic scheduling system. Calendar module 48 can be configured to retrieve meeting data from the calendar system periodically based on fixed time increments or based on some other factors including retrieving the meeting data anytime the data is changed by the calendar system. In one example, travel optimization engine 19 is configured to optimize travel for meetings scheduled for the next day some time prior to the first meeting time of the day. In this manner, travel optimization engine 19 can be configured to process data related to and based thereon optimize travel for a large or small number of meetings as a batch. In such an example, calendar module 48 may be configured to retrieve meeting data from the calendar system one time per day. For example, calendar module 48 may be configured to retrieve the meeting data during employee non-work hours, including, e.g. late at night the day before the scheduled meetings or early in the morning the day of the scheduled meetings. Other time increments may be employed for retrieving meeting data, including, e.g., once per hour, twice daily, once per week, bi-weekly, bi-monthly, once per month, etc.

Calendar module 48 can employ a number of techniques to communicate with calendar system 20. In one example, calendar module 48 employs an application programming interface (API) associated with the calendar system to pull meeting data from the calendar system. In one example, calendar module 48 issues a query, such as a SQL query, to a database or other data. repository associated with the calendar system, which causes the database to return the meeting data 119. one example, calendar module 48 implements a web server that retrieves the data from the calendar system in response to web services requests, such as hypertext transfer protocol (HTTP) requests.

Meeting data module 46 of travel optimization engine 19 is configured to manage meeting data associated with meetings electronically scheduled by an electronic calendar or other scheduling system. Meeting data module 46, for example, can be configured to store and process meeting data retrieved by calendar module 48 from an external calendar system. In one example, meeting data module 46 is configured to receive meeting data from calendar module 48 and store the meeting data on storage devices 42 or another storage medium including a data repository, e.g., like data repository 16 of FIG. 1. In some examples, meeting data received from an external calendar system may be formatted according to a proprietary or other format that cannot be processed by computing device 30. In such examples, meeting data module 46 can be configured to convert the meeting data received from the calendar system into a format that can be processed by computing device 30, e.g., by optimization module 50 of travel optimization engine 19.

Optimization module 50 of travel optimization engine 19 is configured to execute one or more algorithms, programs, applications, and the like to change one or more meeting locations associated with electronically scheduled meetings included in the meeting data, which, in turn, may reduce the travel required of participants of the scheduled meetings. In one example, optimization module 50 retrieves meeting data from meeting data module 46. The meeting data processed by optimization engine 19 includes data representing electronically scheduled meetings, each of which is associated with a meeting location in a multi-story building including at least one elevator, a period of time, and participants of the meeting. As noted above, in one example, travel optimization engine 19 is configured to optimize travel for meetings scheduled for the next day some time prior to the first meeting time of the day and, in this manner, process meeting data for a number of meetings as a batch. In such an example, optimization module 50 may be configured to retrieve meeting data from meeting data module 46 during employee non-work hours, including, e.g. at midnight the day before the scheduled meetings. Optimization engine 19 may process meeting data at periodic intervals other than once per day, including, e.g., once per hour, twice daily, once per week, bi-weekly, bi-monthly, once per month, etc.

Optimization module 50 can also determine a participant location for each participant associated with each meeting. The participant location includes a location at which the participant is anticipated to be prior to the meeting with which the participant is associated by the meeting data. In one example, server 18 and/or data repository 16 may store biographical and other data related to meeting participants, including, e.g., each participant's office or other workspace location. In one example, participant locations may default to each participant's office or other workspace location such that optimization module 50 may determine a participant's location prior to a meeting as the participant's workspace in the absence of any data or other information to indicate otherwise. In another example, optimization module 50 may analyze the meeting data to determine if a participant is associated with another scheduled meeting before the meeting currently being processed by optimization module 50. In such a case, optimization module 50 may determine the participant's location as the meeting location associated with the prior meeting.

Optimization module 50 also determines a meeting travel metric for each of the meetings included in the meeting data. Although possibly expressed in different forms, e.g., distance or time, the meeting travel metric is indicative of a distance between each participant location of each participant and the meeting location. The distance between each participant location and the meeting location is based at least in part on the number of floors the participant travels from the participant location to the meeting location to attend the meeting. Optimization module 50 communicates with calendar system 20 to cause calendar system 20 to change the meeting location associated with one or more of the meetings based on the meeting travel metric of each meeting.

Although shown as separate components in FIG. 2, in some examples, one or more of travel optimization engine 19, meeting data module 46, calendar module 48, and optimization module 50 can be part of the same module. In some examples, one or more of travel optimization engine 19, meeting data module 46, calendar module 48, and optimization module 50 are formed in a common hardware unit. In some instances, one or more of travel optimization engine 19, meeting data module 46, calendar module 48, and optimization module 50 are software and/or firmware units that are executed on processors 38. In general, the modules of travel optimization engine 19 are presented separately for ease of description and illustration. However, such illustration and description should not be construed to imply that these modules of travel optimization engine 19 are necessarily separately implemented, but can be in some examples.

Additionally, although the foregoing examples have been described with reference to travel optimization engine 19 including meeting data module 46, calendar module 48, and optimization module 50, in other examples such function/processing engines or other mechanisms configured to operate in accordance with the disclosed examples can be physically and/or logically differently arranged. For example, travel optimization engine 19 can includes an optimization module, which is configured to retrieve or otherwise reference meeting data from an external calendar or other electronic scheduling system. A wide variety of other logical and physical arrangements are possible in order to implement the functionality attributed to the example of travel optimization engine illustrated in FIGS. 1 and 2.

Computing device 30 includes operating system 44. Operating system 44, in some examples, controls the operation of components of computing device 30. For example, operating system 44, in one example, facilitates the communication of travel optimization engine 19 with processors 38, display 32, user interface 34, and communication units 36.

Computing device 30 can include additional components not shown in FIG 2. For example, computing device 30 can include a battery to provide power to the components of computing device 30. Similarly, the components of computing device 30 may not be necessary in every example of computing device 30. For instance, in certain examples computing device 30 may not include display 32.

FIG. 3 is a flowchart illustrating an example method of reducing the amount of travel required of participants to attend a meeting. The method described with reference to and illustrated in FIG. 3 is an illustrative example. The example method therefore includes features, functions, and reference to particular circumstances that are not necessarily required to carry out some examples according to this disclosure. Additionally, the method of FIG. 3 is described as carried out by components of system 10 of FIG. 1 and computing device 30 of FIG. 2. However, in other examples, methods of reducing meeting travel according to this disclosure may be carried out by other computing devices and other components.

The example method of FIG. 3 includes retrieving, by a computing device, meeting data from an electronic scheduling system (100). The meeting data includes a plurality of meetings, each of which is associated with a meeting location in a building including a plurality of floors and at least one elevator, a period of time, and one or more participants. The example method also includes determining, by the computing device, a plurality of participant locations for each participant (102). The participant location includes a location at which the participant is anticipated to be prior to the meeting with which the participant is associated by the meeting data. The computing device determines a meeting travel metric for each of the meetings (104). The meeting travel metric is indicative of a distance between each participant location of each participant and the meeting location, which distance includes the number of floors the participant travels from the participant location to the meeting location to attend the meeting. The computing device causes the scheduling system to change the meeting location associated with one or more of the meetings based on the meeting travel metric (106).

Meeting participants and organizers may organize and schedule meetings using an electronic calendar or other scheduling system. Such calendar system may include data about meetings, but also about participants and building facilities, e.g. conference rooms, audio/video equipment, etc., that may be used for conducting meetings. The electronic calendar system may also be integrated with other applications, systems, functions, etc. that allow participants to communicate about meeting and other issues, including, e.g., an electronic mail application. In one example, a calendar system allows meeting participants and organizers to create, edit, communicate, and schedule meetings electronically. The calendar system includes functions for electronic communications including electronic mail, short message service (SMS) text messaging, instant messaging system (IMS), and combinations thereof. Such communication mechanisms can be employed by participants and the calendar system to communicate about electronically scheduled meetings, including, e.g., sending meeting notifications.

in one example, a meeting participant and/or organizer may electronically schedule a meeting using the calendar system. The participant can, for example, generate a meeting request that associates the meeting with a number of other participants, a time period over which the meeting is to occur, and a particular location in a building at which the participants are to meet. The calendar system can he configured to send an electronic meeting request to all of the participants to notify them of the meeting and request that each participant indicate, whether they will be able to attend the meeting. After one or more of the participants accept the meeting request, the calendar system may generate the meeting, including generating a calendar event on all participant calendars and also reserving the meeting location and associated resources, e.g. audio/video equipment, for the period of time over which the meeting is scheduled to occur. interaction and execution of functions related to scheduling and managing meetings electronically may be carried out using a system similar to system 110 illustrated in FIG. 1, including participants employing clients 12 in communication with calendar system 20 to create, edit, communicate, and schedule meetings electronically.

In one example, calendar system 20 receives a number of requests and generates a number of meetings in a number of time slots over a period of time. For example, calendar system 20 may generate meetings in various locations of the building at a number of time slots, e.g. 30 minute or some other time increments, for one day. As the meetings are electronically scheduled, calendar system 20 may store data related to the meetings, including, e.g., location, participants, and meeting time. After a number of meetings have been scheduled fir a particular time period, e.g., for one day using calendar system 20, travel optimization engine 19 may process the meeting data to reduce the amount of travel required by participants to attend meetings scheduled by calendar system 20.

Referring again to FIG. 3, in one example, calendar module 48 of travel optimization engine 19 retrieves meeting data from an electronic scheduling system (100). In one example, calendar module 48 is configured to receive meeting data periodically pushed, e.g., once per day by the calendar system to computing device 30. In another example, calendar module 48 of travel optimization engine 19 periodically pulls the meeting data, e.g., once per day from calendar system 20. Calendar module 48 can employ a number of techniques to communicate with calendar system 20. In one example, calendar module 48 employs an application programming interface (API) associated with calendar system 20 to pull meeting data from the calendar system. In one example, calendar module 48 issues a query, such as a SQL query, to a database or other data repository associated with calendar system 20, which causes the database to return the meeting data. In one example, calendar module 48 implements a web server that retrieves the data from calendar system 20 in response to web services requests, such as hypertext transfer protocol (HTTP) requests. Regardless of the particular technique of obtaining the data, in one example, calendar module 48 retrieves meeting data from calendar system 20, which includes meetings scheduled for one day, each of which is associated with a meeting location, a number of participants, and a time period over which the meeting is scheduled to occur.

Travel optimization engine 19 can be configured to determine a participant location for each participant (102). In one example, optimization module 50 of travel optimization engine 19 determines the participant location for each participant. The participant location includes a location at which the participant is anticipated to be prior to the meeting with which the participant is associated by the meeting data. In one example, server 18 and/or data repository 16 may store biographical and other data related to meeting participants, including, e.g., each participant's office or other workspace location. In one example, participant locations may default to each participant's office or other workspace location such that optimization module 50 may determine a participant's location prior to a meeting as the participant's workspace in the absence of any data or other information to indicate otherwise. In another example, optimization module 50 may analyze the meeting data to determine if a participant is associated with another scheduled meeting before the meeting currently being processed by optimization module 50. In such a case, optimization module 50 may determine the participant's location as the meeting location associated with the prior meeting,

In one example, optimization module 50 determines a participant location for each participant by analyzing the meeting data to determine a prior meeting location at which the participant is scheduled to be before the meeting currently being processed by optimization module 50. In this example, optimization module 50 then determines the participant location as the prior meeting location.

In another example, optimization module 50 determines a participant location for each participant by determining a default workspace of the participant in the building. For example, optimization module 50 may search participant data stored in data repository 16, locally on server 18, or another storage mechanism, which data indicates the office, cubicle, or other workspace location of the participant in the building. Optimization module 50 can then determine the participant's location prior to a meeting as the participant's workspace in the absence of any data or other information to indicate otherwise.

In the example method of FIG. 3, optimization module 50 also determines a meeting travel metric for each of the meetings included in the meeting data (104) and causes the calendar system to change the meeting location associated with one or more of the meetings based on the meeting travel metric (106). The travel metric for an electronically scheduled meeting is a mechanism for measuring the amount of travel required of participants to attend the meeting. Although possibly expressed in different forms, e.g., distance or time, the meeting travel metric is indicative of a distance between each participant location of each participant and the meeting location. The distance between each participant location and the meeting location is based at least in part on the number of floors the participant travels from the participant location to the meeting location to attend the meeting.

Optimization module 50 can determine the meeting travel metric for each meeting in a number of different ways. In one example, optimization module 50 determines the distance between each participant location of each participant and the meeting location and sums all of the distances between each participant location of each participant and the meeting location to determine a total meeting travel distance.

Travel distance between locations in a building can be expressed in different ways and can include or be dependent on different factors, including, e.g., characteristics of the building. In one example, the building includes multiple banks of elevators, each of which is configured to service a range of the floors of the building. Travel between different locations in the building with a multi-bank elevator system may be significantly increased because traveling only a few floors can require a disproportionately long elevator ride on multiple banks of elevators. For example, for a meeting participant that is located on the 15^{th} floor of a building that includes a first bank of elevators that service floors 1-14 and a second bank of elevators that service floors 15-25, the participant will have to travel 29 floors by elevator to attend a meeting located on the 14^{th} floor. In this example, the participant would travel on the second bank of elevators from the 15^{th} floor down to floor 1, which is serviced by all of the banks of elevators in the building. Then the participant would go from the second bank of elevators to the first and travel from the 1^{st} floor to floor 14 to attend the meeting.

Travel between multiple banks of elevators, such as described in the foregoing example, can be accounted for and included in the determination of the meeting travel metric by optimization module 50. In one example, optimization module 50 determines that the participant location of at least one participant of a meeting is serviced by a first one of the banks of elevators and the meeting location is serviced by a second one of the banks of elevators that is different than the first one of the banks of the elevators. Optimization module 50 determines a first number of floors between the participant location of the at least one participant and a location serviced by both the first one of the banks of elevators and the second one of the banks of elevators. Optimization module 50 determines a second number of floors between the meeting location and the location serviced by both the first one of the banks of elevators and the second one of the banks of elevators and sums the first number of floors and the second number of floors. Optimization module 50 can repeat the foregoing functions for each participant in the meeting and sum the participant travel distances, expressed in the number of floors in this example, to determine the total meeting travel distance for the meeting.

In a multi-floor building, although elevators are available to travel between meetings, participants may not always choose to use them. This may be particularly true in buildings including multiple banks of elevators as described in the foregoing example. Consider again the example in which the meeting participant located on the 15^{th} floor has to travel 29 floors by elevator to attend a meeting located on the 14^{th} floor. Instead of traveling on the second bank of elevators from floor 15 to 1, and then traveling on the first bank from floor 15 to 1 to attend the meeting, the participant could simply use the stairs and walk from the 15^{th} floor down to the 14^{th}. Thus, in some examples, it would be advantageous for optimization module 50 to account for participants that walk between locations to attend a meeting instead of traveling by elevator.

In one such example, optimization module 50 determines that the participant location of a participant of a meeting is serviced by a first bank of elevators and the meeting location is serviced by a second bank of elevators that is different than the first bank. Optimization module 50 also determines that the number of floors between the participant location and the meeting location is less than or equal to a walk distance threshold associated with the participant. The walk distance threshold can represent a maximum number of floors the participant will walk between locations without using an elevator in the building. Walk distances can be stored and referenced by optimization module 50 in a variety of ways. In one example, calendar system 20 can be configured to store data representing individual user preferences including a walk distance threshold. In such an example, the meeting data retrieved by calendar module 48 and processed by optimization module 50 can include walk distance thresholds for participants of the meetings included in the meeting data. In another example, participant data including walk distance thresholds may be stored in a database or other data repository separate from calendar system 20, which can be retrieved or otherwise referenced by optimization module 50 to determine walk distance thresholds and other information related to meeting participants.

In this example, after determining that the number of floors between the participant location and the meeting location is less than or equal to the walk distance threshold associated with the participant, optimization module 50 can set the distance between the participant location of the participant and the meeting location as the number of floors between the participant location of the participant and the meeting location. Thus, in the example in which the participant would need to travel 29 floors through two banks of elevators (from floor 15 to 1 and then from floor 1 to 14) to attend a meeting or walk 1 floor and the participant's walk distance threshold is equal to or greater than 1 floor, optimization module 50 can set the distance between the participant location of the participant and the meeting location as 1 floor.

In some examples according to this disclosure the meeting travel metric may be expressed in time instead of distance. In one such example, optimization module 50 determines an estimated time to travel the distance between each participant location of each participant and the meeting location and sums the estimated times to travel the distances between each participant location of each participant and the meeting location to determine a total meeting travel time. Travel time between locations in the building can be a function of a number of different factors, including, e.g., the average speed a participant walks, the distance between locations, the amount of time that is spent waiting for elevators, and the number of elevator stops and the amount of time each stop will take between the participant location and the meeting location, and other factors. In one example, optimization module 50 determines a wait time including an estimate of an amount of time the participant will wait for an elevator. For example, optimization module 50 retrieve a predetermined estimate of elevator wait times for the building. Elevator wait times may vary or be fixed, For example, elevator wait times may vary by the time of day and/or the floor at which the participant waits for the elevator. In one example, wait times may be greater at certain times of day and/or for certain floors, e.g., floor 1 in the early morning and after lunch may include large wait times due to the increased elevator traffic at these times.

Optimization module 50 can also determine an estimate of the time the participant will wait in the elevator during one or more elevator stops between the participant location of the participant and the meeting location. In one example, optimization module 50 determines the number of floors between the participant location of the participant and the meeting location and the number of elevator stops between the participant location and the meeting location based at least in part on the number of floors. Optimization module 50 then determines the estimate of the time the participant will wait in the elevator during one or more elevator stops between the participant location of the participant and the meeting location by multiplying the number of elevator stops by an estimate of the time the participant will wait in the elevator during one elevator stop. The time for one stop and the number of stops between two different locations may vary or be fixed. For example, certain banks of elevators may experience more and longer stops than other banks because of the number of participants that work on the floors serviced by a particular bank or the amount of meeting activity on the floors, or both. In any event, after an estimate of elevator wait time and elevator stops time, optimization module 50 can, in one example, ad the wait time and the elevator stops time for each participant to the total meeting travel time.

Referring again to the example method of FIG. 3, optimization module 50 of travel optimization engine 19 causes calendar system 20 to change the meeting location of reservations based on the meeting travel metric (106). As noted above, optimization module 50 can be configured to cause calendar system 20 to change the meeting location of reservations based on the meeting travel metric in a variety of ways. In general, however, optimization module 50 executes an optimization configured to minimize the travel, e.g. distance and/or time, required of participants to attend a meeting in the building. In one example, optimization module 50 executes an optimization that is configured to minimize the total travel of all participants for each meeting included in the meeting data retrieved from calendar system 20. In such cases, a solution reached by optimization module 50 for a given meeting may not change or even increase travel for one or more individual participants of the meeting, but will nevertheless reduce the total travel of all participants of the meeting.

An example of travel between and travel distance optimization involving multiple banks of elevators is illustrated in FIGS. 4 and 5, each of which is a conceptual diagram illustrating participant travel between a participant location and a meeting location to attend a scheduled meeting. The example of FIGS. 4 and 5 include travel to meetings in a building including two banks of elevators. Elevator bank 1 services floors 1-14 of the building and elevator bank 2 services floor 1 and floors 15-25. In this example, a meeting is scheduled between three participants, including participant 1, participant 2, and participant 3 and is scheduled to occur at a conference room on the floor 12 of the building.

Prior to the meeting, the participant locations of each of participant 1, participant 2, and participant 3 can be determined, e.g., by optimization module 50 of optimization engine 19. Determination of participant locations can be executed in the example of FIGS. 4 and 5 in a similar manner as described above including based on participant biographical data stored at any of a number of locations/devices and/or based on a location at which a participant is scheduled to be before the meeting currently being processed by optimization module 50. In the example of FIGS. 4 and 5, optimization module 50 determines that the participant location of participant 1 is floor 20, the location of participant 2 is floor 15, and the location of participant 3 is floor 2, each of which could include the participant's default workspace or a prior meeting location of the participant.

As noted above, optimization module 50 can determine the meeting travel metric for each meeting in a number of different ways. In the example of FIGS. 4 and 5, optimization module 50 determines the meeting travel metric for each meeting as a function of the number of floors between each participant location and the meeting location. Thus, in this example, optimization module 50 determines that participant 1 must travel 25 floors between the participant's current location on floor 15 and the currently scheduled meeting location on floor 12. The reason for the long travel distance for participant 1 is that the participant must travel from floor 15 down to floor 1 on elevator bank 2 and then cross over to elevator bank 1 and travel from floor 1 to floor 12, which is represented in FIG. 4 as travel along path 1-A. Optimization module 50 determines that participant 2 must travel 30 floors between the participant's location on floor 12 and the currently scheduled meeting location on floor 12 The reason for the long travel distance for participant 2, similar to that of participant 1, is that participant 2 must travel from floor 20 down to floor 1 on elevator bank 2 and then cross over to elevator bank 1 and travel from floor 1 to floor 12, which is represented in FIG. 4 as travel along path 2-A. Optimization module 50 determines that participant 3 must travel 10 floors between the participant's location on floor 2 and the currently scheduled meeting location on floor 12, which is represented in FIG. 4 as travel along path 3-A. Thus, in one example, optimization module 50 determines that the meeting travel metric for the meeting between participant 1, participant 2, and participant 3 is a total of 65 floors.

In one example, optimization module 50 of travel optimization engine 19 causes calendar system 20 to change the meeting location of the meeting for participant 1, participant 2, and participant 3 based on the determined meeting travel metric. As noted above, optimization module 50 can be configured to cause calendar system 20 to change the meeting location of reservations based on the meeting travel metric in a variety of ways. In general, however, optimization module 50 executes an optimization configured to minimize the travel, e.g. distance and/or time, required of participants to attend a meeting in the building. In one example, optimization module 50 executes an optimization that produces the result for the meeting between participant 1, participant 2, and participant 3 illustrated in FIG. 5.

As shown in FIG. 5, optimization module 50 changes the meeting location for participant 1, participant 2, and participant 3 from the conference room on floor 12 to a conference room on floor 15. In this example, although participant 3 must travel a slightly greater distance (5 more floors) and switch elevator banks, the travel for participants 1 and 2 has been greatly reduced from 30 floors to 5 and from 25 floors to 0, respectively. The new travel paths of participant 1, participant 2, and participant 3 to the new meeting location on floor 15 is represented in FIG. 5 as travel along paths 1-B, 2-B, and 3-B, respectively. this manner, the solution reached by optimization module 50 for this meeting has increased travel for one of the participants of the meeting, but has nevertheless reduced the total travel of all participants of the meeting from 65 to 20 floors.

The optimization executed by optimization engine 19 can include one or more algorithms based on a variety of optimization techniques to minimize the total travel for all participants of each meeting of the meeting data retrieved from calendar system 20. In one example, travel optimization engine 19 employs a brute force optimization technique that iterates through every possible meeting location for each meeting and associated participants in each time slot, e.g., 30 minute increments, over a larger period of time, e.g., one day, to reach a solution that minimizes the total travel for all participants of each meeting of the meeting data retrieved from calendar system 20. In other examples, travel optimization engine 19 may employ various techniques to potentially narrow the number of combinations iterated through to reach a solution that minimizes travel, including, e.g. applying one or more heuristics to limit the number of possible combinations included in the optimization or to begin by iterating through combinations with a higher likelihood of producing an acceptable solution.

In one example, optimization module 50 analyzes the meeting data retrieved from calendar system 20 and the determined travel metric for each meeting and determines which meeting has the largest travel metric, whether the greatest total meeting travel distance, time, or some other measure of meeting travel. Optimization module 50 then determines anew meeting location for the meeting with the largest travel metric. The new meeting location is determined by optimization module 50 based on a new travel metric for the new location. In one example, optimization module 50 iterates through different possible meeting locations for the meeting with the largest travel metric. For each possible new location, optimization module 50 determines the new travel metric, which may be a function of travel distance, time, other factors, and combinations thereof. Optimization module 50 can then determine a new meeting location that yields the lowest new meeting travel metric, e.g., the shortest total travel distance or time. Optimization module 50 can repeat this process of determining the meeting with the most travel and determining anew location for the meeting that reduces the travel for participants for each meeting included in the meeting data retrieved from calendar system 20. In one example, after iterating through all of the meetings in the meeting data, optimization module 50 can cause calendar system 20 to change the meeting location of one or more meetings to new locations that reduce travel. In another example, while iterating through all of the meetings in the meeting data, can iteratively cause calendar system 20 to change the meeting location of each meeting to the new location that reduce travel for that meeting.

The optimization executed by optimization module 50 to reduce travel for participants of the meetings can include one or more constraints. In one example, optimization module 50 is configured to execute an optimization configured to minimize the travel, e.g. distance and/or time, required of participants to attend a meeting in the building subject to constraints regarding the meeting time. In other words, optimization module 50 may be configured such that, while the locations may change, meetings are required to occur at the same time.

In one example, optimization module 50 is configured to execute an optimization configured to minimize the travel, e.g. distance and/or time, required of participants to attend a meeting in the building subject to constraints regarding the meeting location. For example, optimization module 50 can be configured to only consider new meeting locations that include a meeting participant capacity that is equal to or greater than the current meeting location at which the meeting is scheduled to occur. Thus, in one example, optimization module 50 iterates through different possible meeting locations for the meeting with the largest travel metric. However, optimization module 50 only considers possible meeting locations that include a participant capacity that is greater than or equal to the current meeting location. The capacity for meeting locations can be included the meeting data or stored in another location that can be retrieved or otherwise referenced by optimization module 50.

In some examples, optimization module 50 is configured to exclude one or more meetings included in the meeting data from consideration for location changes all together. Such an exclusionary constraint can be based on a number of factors, including factors related to particular meeting participants and/or locations. For example, certain meetings may be attended by and/or organized by people whose time is highly valued by an organization, such as executives at a large corporation. In one example, optimization module 50 may be configured to analyze data associated with participants, e.g. indicators of position within an organization like a title, to determine if meetings with which such participants are associated should be excluded from the optimization. In another example, the characteristics of particular locations may warrant exclusion of meetings at the locations from being moved to another location, For example, a limited number of conference rooms in a building may include special resources like whiteboards, audio/video equipment, projectors, videoconferencing capabilities/equipment, and other limited resources. In one example, optimization module 50 may be configured to reference data associated with particular locations in the building that indicates the characteristics of the locations. In the event one or more meetings are scheduled to occur in rooms with special resources, optimization module 50 can be configured to exclude these meetings at these locations from being moved to another location.

As noted above, calendar system 20 can receive a number of requests and generate a number of meetings in a number of time slots over a period of time. In some cases, meeting participants may have the option, via calendar system 20, to respond to meeting requests with a definite or indefinite indication with respect to attendance. For example, a meeting participant may indicate via calendar system 20 that the participant wilt attend the meeting or the participant may indicate that their attendance is tentative. In the case that calendar module 48 receives meeting data including meetings with one or more tentative meeting participants, meeting data module 46 may be configured to automatically disambiguate the meeting data for purposes of reducing travel time. For example, meeting data module 46 may assume that the tentative participants will attend the meeting.

In another example, meeting data module 46 may pass the tentative meeting participant data to optimization module 50, which can be configured to adapt the optimization based on this data. For example, in the course of analyzing the meeting data and determining possible new meeting locations to reduce travel, optimization module 50 may weight tentative meeting participants to place less emphasis on reducing travel of such participants relative to reducing travel of other participants that fully accepted the meeting request.

In another example including tentative meeting participants, optimization module 50 can be configured to assume that the tentative meeting participants will attend, but relax the room participant capacity constraint with respect to such participants. For example, optimization module 50 can be configured to only consider new meeting locations that include a meeting participant capacity that is equal to or greater than the current meeting location at which the meeting is scheduled to occur. However, the capacity requirement of the new meeting location can be relaxed by optimization module 50 such that the new location does not necessarily accommodate tentative participants.

Another variable that may be included in the meeting data received by calendar module 48 is recurring meetings. For example, calendar module 48 may receive meeting data from calendar system 20 that includes meetings that are one or more occurrence of a regularly recurring meeting scheduled in calendar system 20. In such a situation, optimization module 50 may be configured with one or more constraints for handling recurring meetings. For example, optimization module 50 can be configured to exclude meeting occurrences included in the meeting data that are part of a recurring meeting from consideration for location changes. In another example, optimization module 50 can be configured to include recurring meeting occurrences and to handle such occurrences in substantially the same manner as other types of meetings. In other words, optimization module 50 can be configured to reduce travel for such meeting occurrences in substantially the same manner as described with respect to meetings that are not part of a recurring meeting in calendar system 20.

After one or more meeting locations have been changed to reduce travel, travel optimization engine 19 can be configured to notify participants of the new meeting locations. Meeting notifications can be executed in a variety of ways. In general, however, travel optimization engine 19, calendar system 20, or another component can be configured to generate an electronic notification that indicates the new location of the meeting to inform participants where to go to attend the meeting. In one example, travel optimization engine 19 is configured to control calendar system 20 to generate and send an electronic message to participants that notifies the participants of the meeting location change. In another example, calendar system 20 is configured to automatically generate and send electronic meeting updates anytime the parameters of a meeting, including location are changed.

Electronic notifications of meeting location changes can take a number of forms. For example, meeting participants can be notified via, electronic mail, SMS text messages, IMS messages, and the like. Additionally, meeting data, including time, location, participants, location resources, etc., can be posted for viewing at various locations in the building in which the meetings will occur. For example, conference rooms can include an electronic display device that is configured to display meeting data as meetings occur in the room throughout the day. In such an example, travel optimization engine 19, calendar system 20, or another component can be configured to transmit meeting data to a computing device configured to cause the conference room display to display the data to participants.

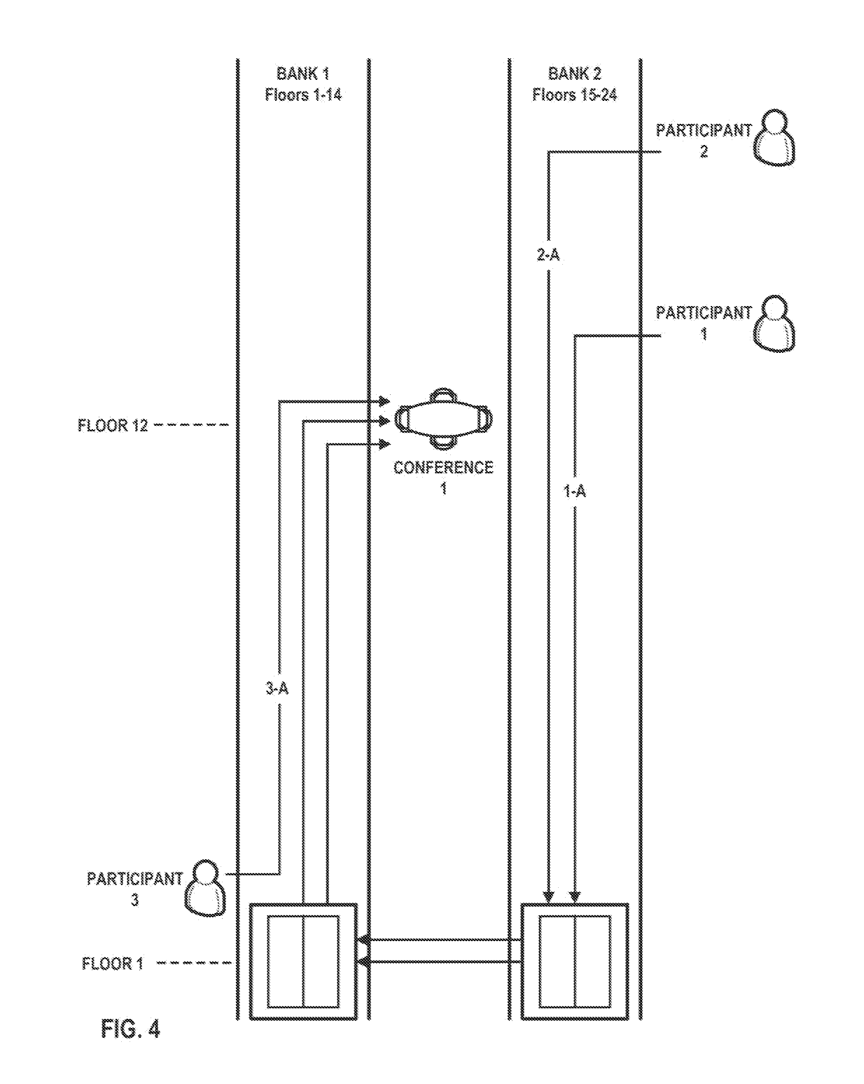

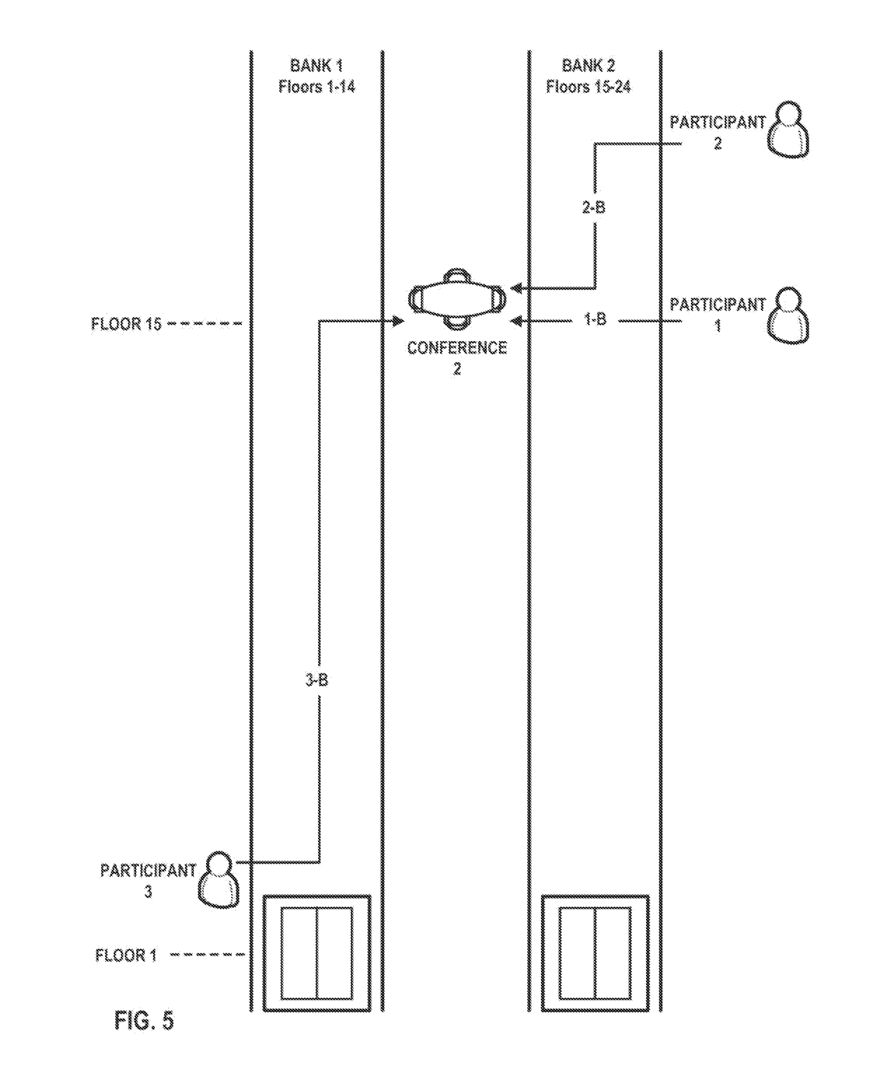

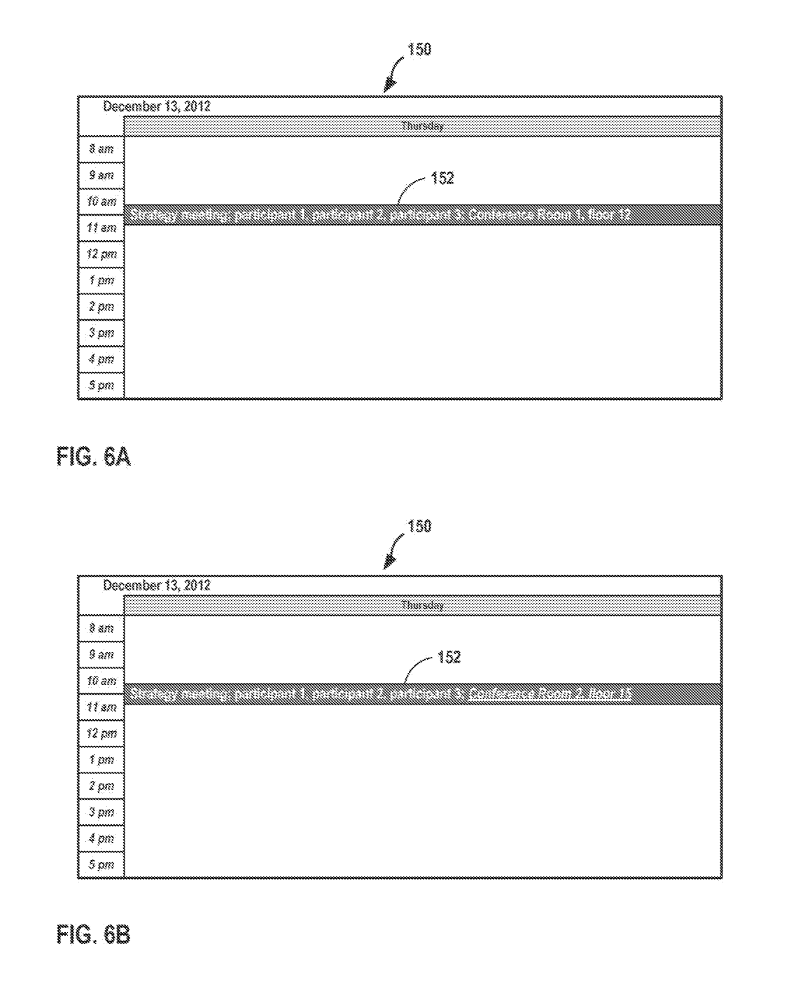

FIGS. 6A and 6B are conceptual diagrams illustrating an example meeting notification that can be used to inform meeting participants of meeting changes generated by travel optimization engine 19. FIG. 6A is a graphical illustration of a portion of user interface 150 of calendar system 20, or another such scheduling system. FIG. 6A illustrates scheduled meeting 152 on a user's calendar for a particular day. The example of FIGS. 6A and 6B show meeting notices posted on a user's calendar in calendar system 20 that are associated with the meeting illustrated in and described with reference to FIGS. 4 and 5. Thus, in FIG. 6A, meeting 152, entitled, “TSS strategy meeting,” is scheduled to occur on floor 12 of the building between participants 1, 2, and 3, from 10:30-11:30 am. In this manner, meeting 152 reflects the status of the meeting between participants 1, 2, and 3 before optimization module 50 of travel optimization engine 19 has changed the meeting location.

After the meeting location of the meeting between participants 1, 2, and 3 has been changed to reduce travel, travel optimization engine 19 can be configured to control calendar system 20 to modify the meeting notice on each of the participant's electronic calendar. Such an example is illustrated in FIG. 6B, which includes meeting 152 now scheduled to occur at conference room 2 on floor 15.

In some examples, participants can specify the manner in which they would like to receive electronic meeting notifications and updates. For example, calendar system 20 can be configured to store data representing individual user preferences with regard to meeting notifications. In such an example, the meeting data received by calendar module 48 can include participant preferences for meeting notification delivery. In another example, participant data including meeting notification preferences may be stored in a database or other data. repository separate from calendar system 20, which can be retrieved or otherwise referenced by travel optimization engine 19, calendar system 20, or another component to determine how to send meeting notifications to particular participants.

The foregoing examples include situations in which the travel metric determined by optimization module 50 of travel optimization engine 19 corresponds to travel distances and/or times required to attend meetings. However, other measures of meeting travel may also be used. For example, a scoring system could be employed in which the travel metric for a meeting is equal to an integer value that is determined based on a number of factors, including distance traveled, time of travel, floors traveled, whether travel to the meeting requires multiple banks of elevators, and/or a number of other factors.

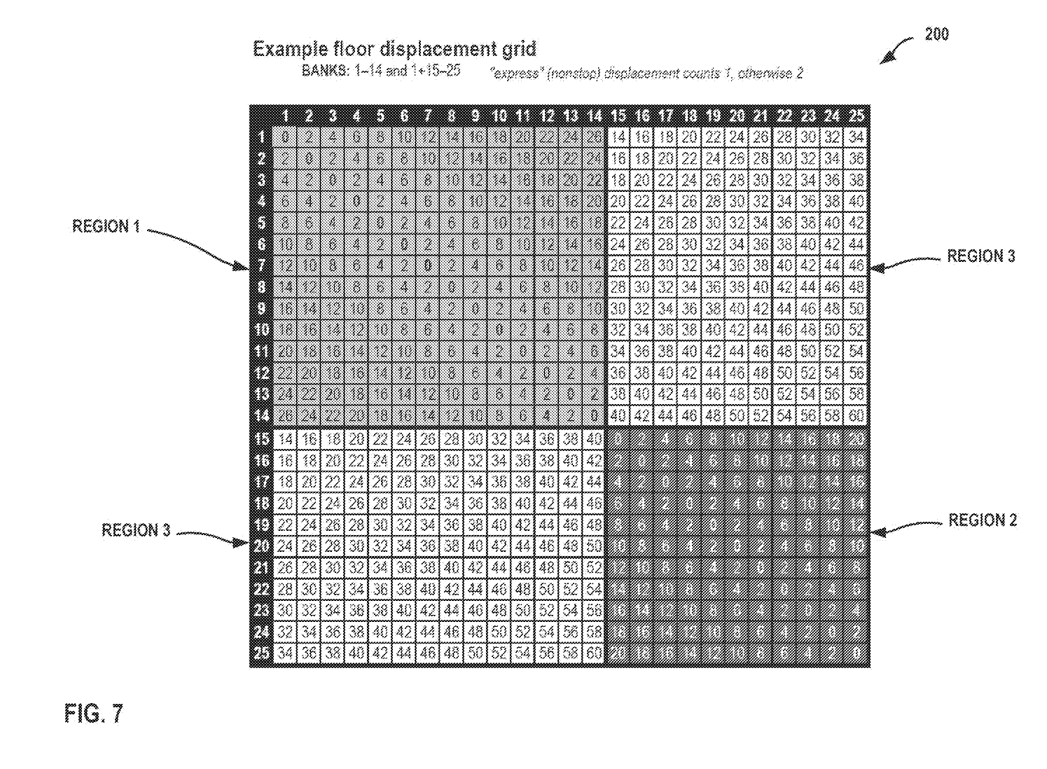

One example of such a scoring system is illustrated in the floor displacement grid of FIG. 7. Floor displacement grid 200 of FIG. 7 is constructed for the same example illustrated in FIGS. 4 and 5, in which the building in which meetings occur includes two banks of elevators, one of which services floors 1-14 and the other of which services floor 1 and floors 15-25. Floor displacement grid includes three regions of data including region 1, region 2, and region 3 illustrated in FIG. 7. Region 1 includes data for travel between floors 1-14 via elevator bank 1. Region 2 includes data for travel between floors 1 and 15-25 via elevator bank 2. In this example, travel between floor 1 and floor 15 on elevator bank 2 is “express” or non-stop travel. Region 3 includes data for travel between any of floors 1-14 and any of floors 15-25 using both elevator bank 1 and elevator bank 2.

The data represented in floor displacement grid 200 could be stored at a number of different devices, including at storage devices 42 of computing device 30. Additionally, the data represented in floor displacement grid 200 could be stored in a number of forms and formats, including in a spreadsheet, in a database or other table, or in another form. In one example, an algorithm including mathematical formulas that automatically calculate floor displacement/meeting travel metrics based on a start and end floor could be employed by optimization module 50 to generate the data represented in the floor displacement grid.

In the scoring system represented by floor displacement grid 200, travel between each of floors 1-14 on elevator bank 1 and travel between each of floors 15-25 on elevator bank 2 counts as 2 points per floor traveled. Travel between floors 1 and 15 on elevator bank 2, however, counts only as 1 point per floor traveled. The weighting of travel between different floors represents a difference in travel time, where travel between floors 1 and 15 is “express” or without any stops, while all of the other travel may include stopping.

In one example, optimization module 50 employs floor displacement grid 200 to determine floor displacement scores for meeting participants and sums the displacements to determine meeting travel metrics. For example, optimization module 50 could determine that the floor displacement score for participant 1 to travel to the original meeting location in the example of FIGS. 4 and 5 would be equal to 36 and the floor displacement score for participant 1 to travel to the changed meeting location would be 0.

The foregoing examples include situations in which travel to meetings includes travel by elevator between different locations in a multi-story building. However, examples according to this disclosure can be applied to reduce meeting travel in other contexts, including facilities with characteristics other than travel between large numbers of floors and/or across multiple banks of elevators. For example, examples according to this disclosure could be applied to facilities that include a large campus of multiple building, such as large corporate or university campus with multiple buildings. Although each building may include relatively limited number of floors, e.g. within a range many employees would be willing to walk between, travel from a participant location in one building to a meeting location in another building across the campus could result in large amounts of travel.

Various examples have been described. These and other examples are within the scope of the following claims.

1. A method comprising:
retrieving, by a computing device, meeting data from an electronic scheduling system, wherein the meeting data comprises a plurality of meetings, each of which is associated with a meeting location in a building including a plurality of floors and at least one elevator, a period of time, and one or more participants;
determining, by the computing device, a participant location for each participant associated with each of the meetings;
determining, by the computing device, a meeting travel metric for each of the meetings based on the participant locations and the meeting location of the meeting, wherein the meeting travel metric is indicative of a distance between each participant location of each participant and the meeting location, and wherein the distance is based at least in part on a number of floors the participant travels from the participant location to the meeting location to attend the meeting; and
causing, by the computing device, the scheduling system to change the meeting location associated with one or more of the meetings based on the meeting travel metric determined for each of the one or more of the meetings.

2. The method of claim 1, wherein the participant location comprises a location of a first meeting of the plurality of meetings at which the participant is anticipated to be prior to a second meeting of the plurality of meetings.

3. The method of claim 2, wherein determining, by the computing device, the participant location for each participant comprises analyzing, by the computing device, the meeting data to determine the location of the first meeting at which the meeting data indicates the participant is scheduled to be prior to the second meeting.

4. The method of claim 2, wherein determining, by the computing device, the participant location for each participant comprises determining, by the computing device, a default workspace of the participant in the building.

5. The method of claim 4, wherein the default workspace comprises at least one of an office or a cubicle located on one of the floors of the building.

6. The method of claim 1, wherein determining, by the computing device, the meeting travel metric comprises:
determining, by the computing device, the distance between each participant location of each participant and the meeting location; and
summing, by the computing device, the distances between each participant location of each participant and the meeting location to determine a total meeting travel distance.

7. The method of claim 6, wherein causing, by the computing device, the scheduling system to change the meeting location associated with one or more of the meetings comprises:
determining, by the computing device, a meeting of the plurality of meetings that comprises the greatest total meeting travel distance;
determining, by the computing device, a new meeting location for the meeting based on a new total meeting travel distance comprising a sum of distances between each participant location of each participant and the new meeting location, wherein the new total meeting travel distance is less than the total meeting travel distance; and
causing, by the computing device, the scheduling system to change the meeting location associated with the meeting to the new meeting location.

8. The method of claim 6, wherein the building comprises a plurality of banks of elevators, wherein each of the banks of elevators is configured to service a range of the floors of the building, and wherein determining, by the computing device, the distance between each participant location of each participant and the meeting location comprises:
determining, by the computing device, that the participant location of at least one participant is serviced by a first one of the banks of elevators and the meeting location is serviced by a second one of the banks of elevators that is different than the first one of the banks of the elevators;
determining, by the computing device, a first number of floors between the participant location of the at least one participant and a location serviced by both the first one of the banks of elevators and the second one of the banks of elevators;
determining, by the computing device, a second number of floors between the meeting location and the location serviced by both the first one of the banks of elevators and the second one of the banks of elevators; and
summing, by the computing device, the first number of floors and the second number of floors.

9. The method of claim 6, wherein the building comprises a plurality of banks of elevators, wherein each of the banks of elevators is configured to service a range of the floors of the building, and wherein determining, by the computing device, the distance between each participant location of each participant and the meeting location comprises:
determining, by the computing device, that the participant location of at least one participant is serviced by a first one of the banks of elevators and the meeting location is serviced by a second one of the banks of elevators that is different than the first one of the banks of the elevators;
determining, by the computing device, that a number of floors between the participant location of the at least one participant and the meeting location is less than or equal to a walk distance threshold associated with the at least one participant, wherein the walk distance threshold comprises a maximum number of floors the at least one participant will walk between without using an elevator in the building; and
setting, by the computing device, the distance between the participant location of the at least one participant and the meeting location as the number of floors between the participant location of the at least one participant and the meeting location.

10. The method of claim 9, wherein the meeting data retrieved from the scheduling system comprises the walk distance threshold for the at least one participant.

11. The method of claim 9, further comprising retrieving, by the computing device, the walk distance threshold for the at least one participant from a data source storing data associated with the one or more participants associated with each of the meetings.

12. The method of claim 6, wherein determining, by the computing device, the distance between each participant location of each participant and the meeting location comprises determining, by the computing device, a number of floors between each participant location of each participant and the meeting location.

13. The method of claim 1, wherein determining, by the computing device, the meeting travel metric comprises:
determining, by the computing device, an estimated time to travel the distance between each participant location of each participant and the meeting location; and
summing, by the computing device, the estimated times to travel the distances between each participant location. of each participant and the meeting location to determine a total meeting travel time.

14. The method of claim 13, wherein causing, by the computing device, the scheduling system to change the meeting location associated with one or more of the meetings comprises:
determining, by the computing device, a meeting of the plurality of meetings that comprises the greatest total meeting travel time;
determining, by the computing device, a new meeting location for the meeting based on a new total meeting travel time comprising a sum of estimated travel times to travel distances between each participant location of each participant and the new meeting location, wherein the new total meeting travel time is less than the total meeting travel time; and
causing, by the computing device, the scheduling system to change the meeting location associated with the meeting to the new meeting location.

15. The method of claim 13, wherein determining, by the computing device, the estimated time to travel the distance between each participant location of each participant and the meeting location comprises:
determining, by the computing device, a wait time comprising an estimate of an amount of time the participant will wait for an elevator;
determining, by the computing device, an elevator stops time comprising an estimate of the time the participant will wait in the elevator during one or more elevator stops between the participant location of the participant and the meeting location; and
adding, by the computing device, the wait time and the elevator stops time for each participant to the total meeting travel time.

16. The method of claim 15, further comprising:
determining, by the computing device, a number of floors between the participant location of the participant and the meeting location;
determining, by the computing device, a number of elevator stops between the participant location and the meeting location based at least in part on the number of floors, and
wherein determining, by the computing device, the elevator stops time comprises multiplying, by the computing device, the number of elevator stops by an estimate of the time the participant will wait in the elevator during one elevator stop.

17. The method of claim 1, further comprising generating, by the computing device, an electronic notification configured to inform the participants of the change of the meeting location associated with the one or more of the meetings based on the meeting travel metric.

18. The method of claim 17, wherein the electronic notification comprises at least one of an electronic mail, short message service, or instant messaging system message.

19. The method of claim 1, wherein each period of time associated with each meeting comprises a period of time that is greater than or equal to at least one of 15 minutes, 30 minutes, or 1 hour.

20. A computing device, comprising:
at least one computer-readable storage device; and
at least one processor configured to access information stored on the at least one computer-readable storage device and to perform operations comprising:
obtaining data from an electronic calendar system that indicates a plurality of electronically scheduled meetings, each of which is associated with a meeting location, a period of time, one or more participants, and a location of each participant from which the participant is required to travel to attend the meeting;
determining a new meeting location for one or more of the meetings that reduces travel distance of each of the one or more meetings, wherein the travel distance of each meeting is based on the participant locations and the meeting location; and
causing the calendar system to change the meeting location associated with each of the one or more meetings to the new meeting location.

21. A computer-readable storage medium that includes instructions that, if executed by a computing device having one or more processors, cause the computing device to perform operations that include:
obtaining meeting data from an electronic calendar system for a plurality of electronically scheduled meetings;
determining, for each of the meetings, a meeting location, a period of time, one or more participants, and a location of each participant from which the participant is required to travel to attend the meeting; and
iteratively changing the meeting location of each of the meetings and determining travel distance of the meeting based on the participant locations and the meeting location to reduce a total distance that all participants of the meeting are required to travel to attend the meeting.
